(19) United States
(12) Patent Application Publication
(10) Pub. No.: US 2009/0021242 A1
(43) Pub. Date: Jan. 22, 2009

(54) DEVICE AND METHOD FOR MEASURING A QUANTITY REPRESENTING THE ROTATIONAL SPEED OF A MOTOR VEHICLE AND SYSTEM AND METHOD USING SAID DEVICE AND METHOD

(75) Inventors: Zahir Djama, Paris (FR); Denis Le Bret, Chaville (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/067,175

(22) PCT Filed: Sep. 11, 2006
(86) PCT No.: PCT/FR06/50865

§ 371 Date: Aug. 29, 2008

(30) Foreign Application Priority Data
Sep. 16, 2005 (FR) 0509508

(51) Int. Cl. G01P 3/54; G01M 17/02; G06F 19/00

(52) U.S. Cl. 324/166; 73/146.2; 702/33

(57) ABSTRACT

The invention concerns a device for measuring a quantity representing the rotational speed of a motor vehicle wheel (14ag, 14ad, 14rg, 14rd), comprising means (22ag, 22ad, 22rg, 22rd) for coding and measuring the rotational speed in the form of electromagnetic pulses, means (24) for determining a time interval including a whole number of said pulses, and means (24) for counting the whole number of said pulses during said time interval. Said device comprises means (24) for determining a quantity representing the radius of the wheel and means (24) for determining said quantity based on the whole number of pulses, on the time interval and on the quantity representing the radius of the wheel.

The present invention concerns a device and a method for measuring the longitudinal speed of a vehicle wheel.

More particularly, the present invention concerns such a device including means for encoding the rotation speed in the form of electromagnetic pulses, means for measuring said pulses, means for determining a time period comprising a whole number of said pulses, and means for counting the whole number of pulses during this time period.

The present invention also concerns a system for determining the state of tires of the wheels of a vehicle including such a device and a method of determining the state of tires of the wheels of a vehicle including such a method.

To monitor the operation of a vehicle, such as its braking or its trajectory, measurements of rotation speeds of the vehicle wheels are currently used. These measurements are supplied by rotation speed sensors mounted on the wheels, generally called “ABS sensors.”

An ABS sensor typically has an encoding disk mounted on the axle of a wheel of the vehicle and comprising a plurality of alternating north and south magnetic poles. The ABS sensor also has a housing mounted on the spindle of the wheel facing the disk and connected to a data processing unit. This housing accommodates a printed circuit board on which a Hall effect cell is mounted. This cell produces an electric current as a function of the magnetic field variations generated by the alternating passage in front of the housing of the north and south poles of the disk driven by the axle. Thus, the ABS sensor operates as a magnetic encoder of the rotation speed of the wheel and the current that it generates, or an image thereof, is supplied to the data processing unit which calculates the frequency of the generated current, and consequently the rotation speed of the wheel.

However, the calculation of the frequency of the signal from the ABS sensor implemented by this unit uses a predetermined and constant radius of the wheel. Thus, if this wheel does not have a constant radius, for example, due to the fact that its tire is not inflated in a satisfactory manner, or that a wrong tire has been mounted on the wheel, this calculation is distorted. Applications that use the calculated frequency, such as wheel anti-blocking, tire state diagnostic, trajectory monitoring, or others, are then based on a wrong value, which can become dangerous.

The objective of the present invention is to remedy the above-mentioned problem.

To this effect, an object of the present invention is a device for measuring a quantity representative of the rotation speed of a vehicle wheel, of the type including:
means for encoding the rotation speed of the wheel in the form of electromagnetic pulses;
means for measuring said pulses;
means for determining a time period comprising a whole number of said pulses; and
means for counting the whole number of pulses during this time period,

characterized in that it comprises:
means for determining a magnitude representative of the radius of the wheel; and
means for determining said quantity as a function of the whole number of pulses, of the time period, and of the magnitude representative of the radius of the wheel;
the quantity representative of the rotation speed of the wheel is the frequency of the electromagnetic pulses encoding said speed;
the means for determining the magnitude representative of the radius of the wheel comprise means for acquiring vertical accelerations in a referential of the vehicle of the wheel and of another wheel arranged on a same side of the vehicle as the former, and means for estimating a coefficient of stiffness of a tire mounted on the wheel;
the estimation means comprise means for temporally resetting one of the acquired accelerations on the other of the acquired accelerations;
the means for estimating the coefficient of stiffness are adapted to estimate the latter from a mono-wheel mechanical model of said wheels connected to a body of the vehicle by means of suspensions and having tires assimilated to springs characterized by coefficients of stiffness;
the means for estimating the coefficient of stiffness are adapted to estimate the latter based on a model in discrete time of the reset accelerations of the wheel and of the other wheel according to the equation:

$$Avr ( k ) = \frac{1}{mrr} ( \begin{matrix}mra \times Ava ( k - n ) & Zva ( k - n ) - Zvr ( k )\end{matrix} ) ( \begin{matrix}Kpr ( k ) / Kpa ( k ) \\ Kpr ( k )\end{matrix} )$$

where k is the k^{th} sampling instant, mrr is the mass of the rear wheel among the wheel and the other wheel, mra is the mass of the front wheel among the wheel and the other wheel, Avr and Ava are the vertical accelerations of said rear and front wheels, respectively, Zvr and Zva are the altitudes of the centers of said rear and front wheels, respectively, in the referential fo the vehicle, Kpr and Kpa are the coefficients of stiffness of the tires of said front and rear wheels, respectively, and n is a resetting instant corresponding to a temporal delay between said rear and front wheels subjected to a same portion of the roadway;
the means for estimating the coefficient of stiffness are adapted to estimate the latter based on a model in discrete time of the reset accelerations of the wheel and of the other wheel according to the equation:

$$Ava ( k ) = \frac{1}{mra} ( \begin{matrix}mrr \times Avr ( k + n ) & Zvr ( k + n ) - Zva ( k )\end{matrix} ) ( \begin{matrix}Kpa ( k ) / Kpr ( k ) \\ Kpa ( k )\end{matrix} )$$

where k is the k^{th} sampling instant, mrr is the mass of the rear wheel among the wheel and the other wheel, mra is the mass of the front wheel among the wheel and the other wheel, Avr and Ava are the vertical accelerations of said rear and front wheels, respectively, Zvr and Zva are the altitudes of the centers of said rear and front wheels, respectively, in the referential of the vehicle, Kpr and Kpa are the coefficients of stiffness of the tires of said front and rear wheels, respectively, and n is a resetting instant corresponding to a temporal delay between said rear and front wheels subjected to a same portion of the roadway;
the estimating means are adapted to estimate the coefficient of stiffness based on a bicycle mechanical model of a body of the vehicle assimilated to a mass connected to the wheel and to the other wheel by means of suspensions, the wheel and the other wheel having tires assimilated to springs characterized by coefficients of stiffness;
the means for estimating the coefficient of stiffness are adapted to estimate the latter based on a model in discrete time of the reset accelerations of the wheel and of the other wheel according to the equation:

$$Avr ( k ) = {( \begin{matrix}\frac{mra}{mrr} Ava ( k - n ) \\ \frac{1}{mrr} ( Zva ( k - n ) - Zvr ( k ) ) \\ \frac{1}{mnr} \dot{Z} va ( k - n ) \\ - \frac{1}{mrr} \dot{Z} vr ( k )\end{matrix} )}^{T} ( \begin{matrix}Kpr ( k ) / Kpa ( k ) \\ Kpr ( k ) \\ ( Kpr ( k ) / Kpa ( k ) ) \times Kca ( k ) \\ Kcr ( k )\end{matrix} )$$

where k is the k^{th} sampling instant, mrr is the mass of the rear wheel among the wheel and the other wheel, mra is the mass of the front wheel among the wheel and the other wheel, Avr and Ava are the vertical accelerations of said rear and front wheels, respectively, Zvr and Zva are the altitudes of the centers of said rear and front wheels, respectively, in the referential of the vehicle, Kpr and Kpa are the coefficients of stiffness of the tires of said front and rear wheels, respectively, n is a resetting instant corresponding to a temporal delay between said rear and front wheels subjected to a same portion of the roadway, Kca and Kcr are coefficients of stiffness of the suspensions of said front and rear wheels, respectively, and Żva and Żvr are the speeds of the vertical movements of the centers of said front and rear wheels, respectively;
the means for estimating the coefficient of stiffness are adapted to implement a recursive least square algorithm in real time;
the magnitude representative of the radius of the wheel is a number which is a function of the ratio between the longitudinal speed of the wheel and the frequency of said pulses, and the means for determining this magnitude comprise means for estimating said number as a function of the estimated coefficient of stiffness of the tire of the wheel; and
the means for determining the quantity representative of the rotation speed of the wheel comprise means for selecting an abacus of a predetermined group of abacuses as a function of the determined magnitude representative of the radius of the wheel and of the number of pulses counted and means for estimating said quantity by evaluating the selected abacus for the determined time period.

Another object of the invention is a system for determining the state of tires of the wheels of a vehicle, characterized in that it comprises:
a device of the above-mentioned type associated to each wheel of the vehicle and supplying a quantity representative of the rotation speed of the wheel; and
means for diagnosing the state of the tires of the vehicle wheels as a function of said supplied quantities;
the diagnostic means are adapted to diagnose a tire as being under-inflated when the quantity associated with the latter is lower than a quantity associated with the other tires by more than a first predetermined value;
the devices are adapted to further supply the estimated coefficients of stiffness of the wheels, and the diagnostic means are adapted to diagnose the tire as being under-inflated if, in addition, its estimated coefficient of stiffness is lower than at least one estimated coefficient of stiffness of the other tires by more than a second predetermined value;
the diagnostic means are adapted to diagnose the tires of the vehicle as being under-inflated if said supplied quantities are lower than a predetermined first threshold value;
the diagnostic means are adapted to diagnose the tires of the vehicle as being under-inflated if, in addition, said supplied coefficients are lower than a predetermined second threshold value.

Further, another object of the invention is a method of measuring a quantity representative of the rotation speed of a vehicle wheel, of the type including:
a step of encoding the rotation speed of the wheel in the form of electromagnetic pulses;
a step of measuring said pulses;
a step of determining a time period comprising a whole number of said pulses; and
a step of counting the whole number of pulses during this time period,

characterized in that it comprises:
a step of determining a magnitude representative of the radius of the wheel; and
a step of determining said quantity as a function of the whole number of pulses, of the time period and of the magnitude representative of the radius of the wheel.

Further, another object of the invention is a method of determining the state of tires of the wheels of a vehicle, characterized in that it comprises:
a method of the above-mentioned type for each wheel of the vehicle and supplying a quantity representative of the rotation speed of the wheel; and
a step of diagnosing the state of the tires of the vehicle wheels as a function of said supplied quantities.

The invention will be better understood by reading the following description, which is given by way of example only in reference to the annexed drawings in which identical references designate identical or analogous elements, and in which:

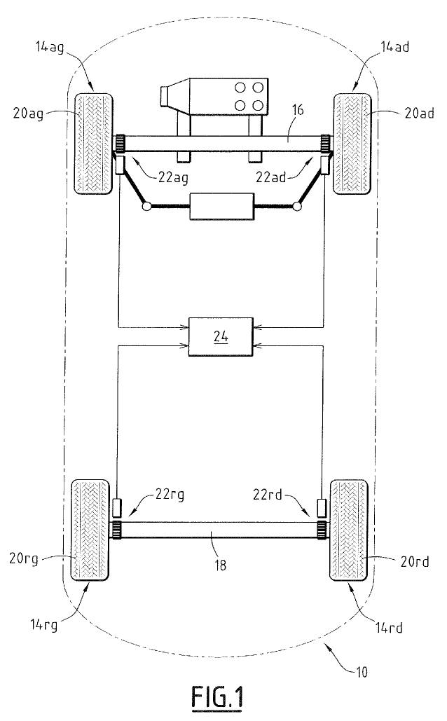

FIG. 1 is a schematic view of a motor vehicle comprising a system for determining the inflated state of tires according to the invention;

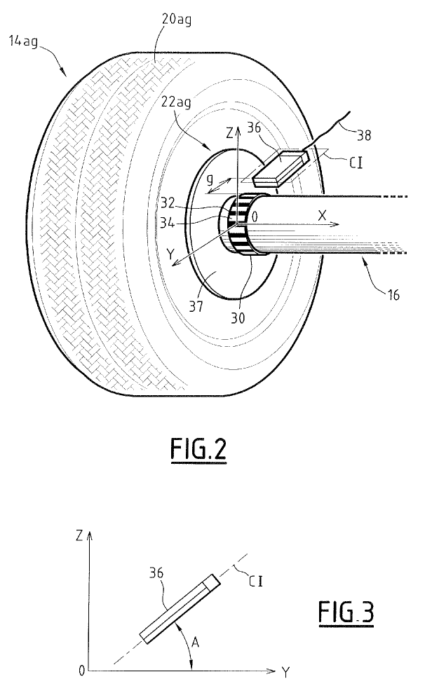

FIG. 2 is a schematic view of a sensor which is part of the constitution of the system of FIG. 1, associated to a wheel train of the vehicle;

FIG. 3 is a side view of the housing of FIG. 1 in an orthogonal referential of the wheel;

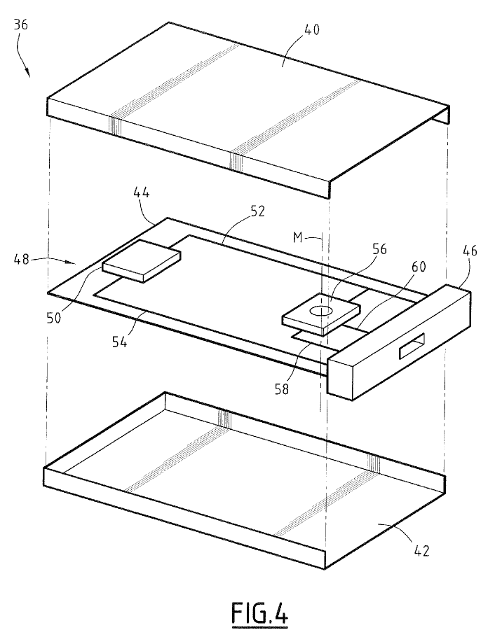

FIG. 4 is a schematic exploded perspective view of a first embodiment of the housing of FIG. 2;

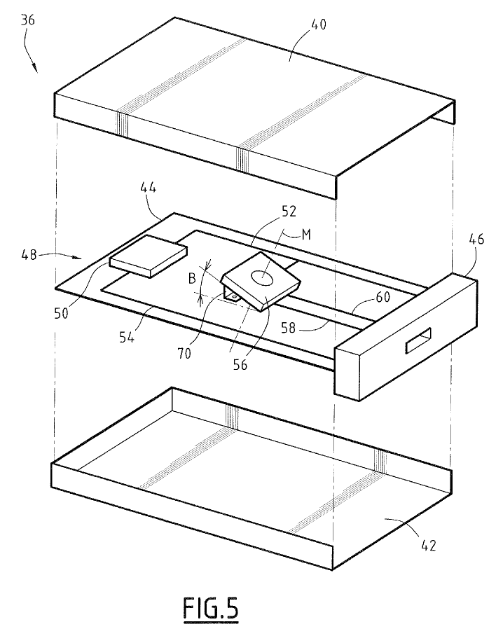

FIG. 5 is a schematic exploded perspective view of a second embodiment of the housing of FIG. 2;

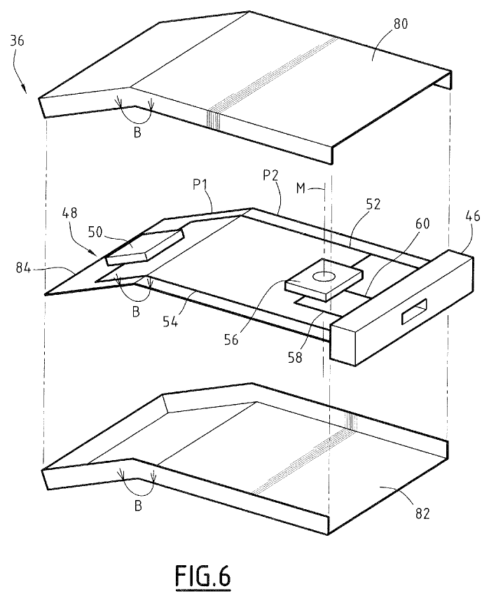

FIG. 6 is a schematic exploded perspective view of a third embodiment of the housing of FIG. 2;

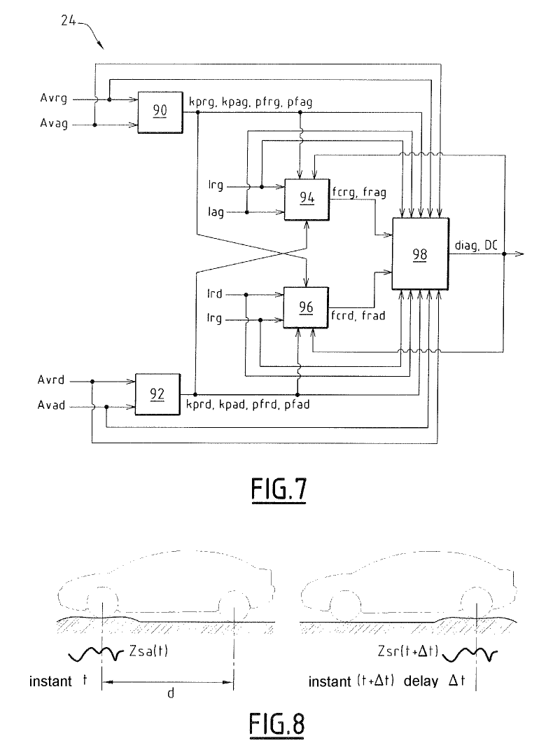

FIG. 7 is a schematic view of a data processing unit which is part of the constitution of FIG. 1;

FIG. 8 is a schematic drawing illustrating a calculation hypothesis used by the unit of FIG. 7;

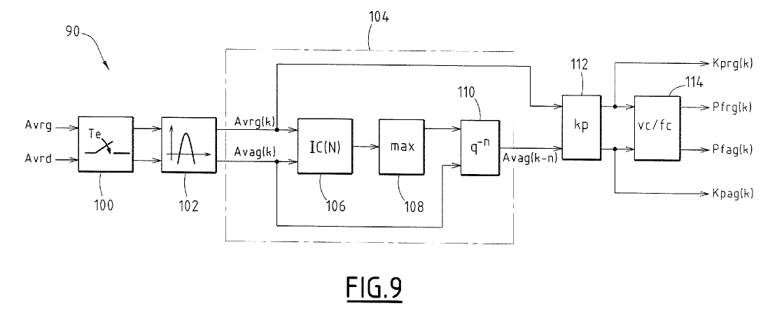

FIG. 9 is a schematic view of a module for the determination of operating points of front and rear wheels which is part of the constitution of the unit of FIG. 7;

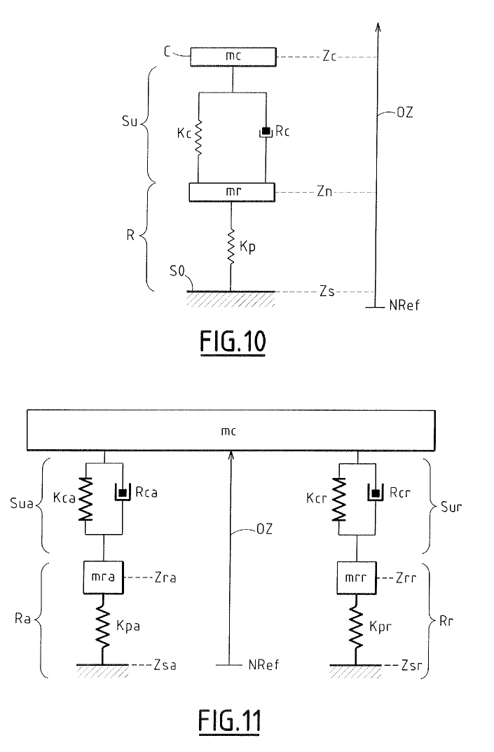

FIG. 10 is a schematic view of a mechanical model of a motor vehicle wheel connected to the body thereof by means of a suspension;

FIG. 11 is a schematic view of a second mechanical model of a motor vehicle front and rear wheel arranged on a same side of the vehicle and connected to the body thereof by means of suspensions;

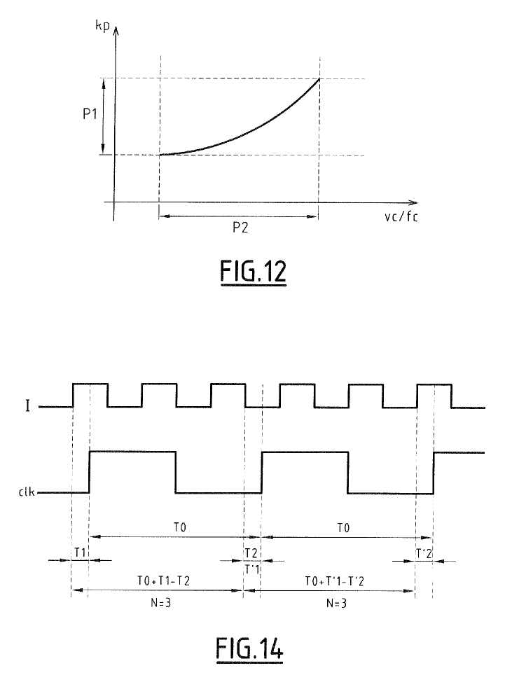

FIG. 12 is a graph of the coefficient of stiffness of a tire mounted on a wheel of the vehicle as a function of the operating point thereof;

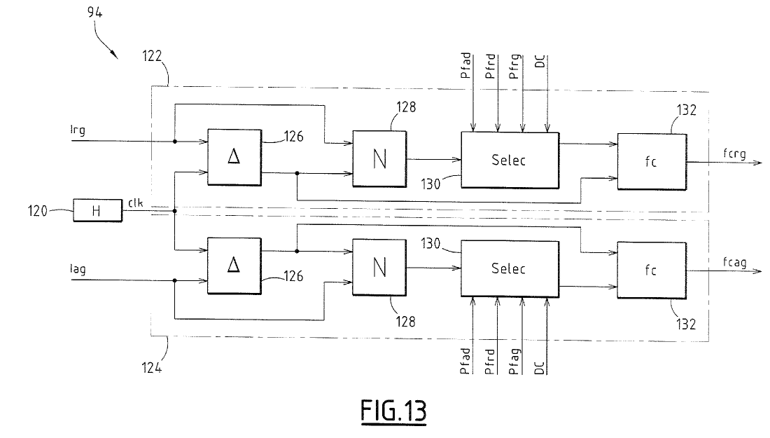

FIG. 13 is a schematic view of a module for the determination of frequencies of electromagnetic pulses which is part of the constitution of the unit of FIG. 7;

FIG. 14 is a graph illustrating the determination of an address of electromagnetic pulses;

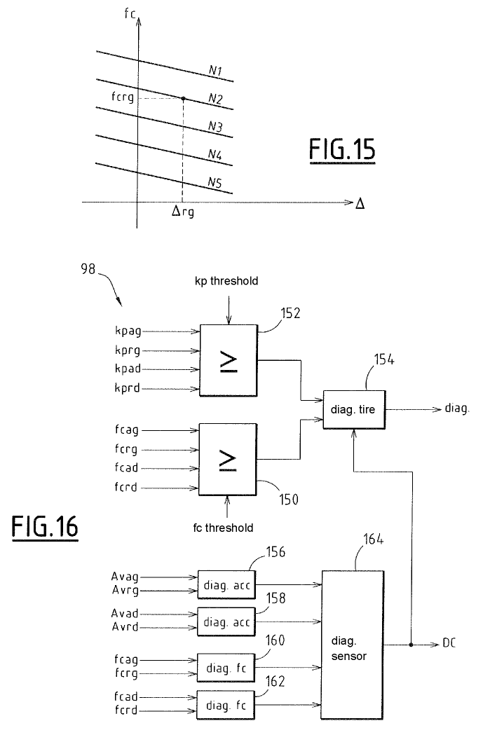

FIG. 15 is a graph of abacuses of frequencies of electromagnetic pulses as a function of addresses of electromagnetic pulses; and

FIG. 16 is a schematic view of a diagnostic module which is part of the constitution of the unit of FIG. 7.

FIG. 1 illustrates schematically a motor vehicle 10 having two, right 14ad and left 14ag, front wheels mounted on a front axle 16 and two, right 14rd and left 14rg rear wheels mounted on a rear axle 18. Each of the wheels 14ag, 14ad, 14rg, 14rd is equipped with a tire 20ag, 20ad, 20rg, 20rd. Each of the wheels is associated also associated with a sensor 22ag, 22ad, 22rg, 22rd encoding its rotation speed in the form of magnetic pulses and measuring an acceleration of the center thereof.

The sensors 22ag, 22ad, 22rg, 22rd are connected to a data processing unit 24 which determines, as a function of the signals supplied by the latter, the frequencies of the pulses encoding the rotation speeds of the wheels 14ag, 14ad, 14rg, 14rd and the state of the tires 20ag, 20ad, 20rg, 20rd, as will be described in more details below.

FIG. 2 is a more detailed view of the wheel train of one of the wheels 14ag, 14ad, 14rg, 14rd, for example, that of the left front wheel 14ag associated with the corresponding sensor 22ag. The other sensors 22ad, 22rg, 22rd are identical to the sensor 22ag described below.

In a standard manner, the wheel 14ag is framed by an orthogonal coordinate system OXYZ in a referential of the vehicle, the OX axis being the transverse axis of the wheel, the OY axis being the longitudinal axis of the wheel, and the OZ axis being the vertical axis of the wheel, as is known in itself. The OXY plane is called horizontal plane of the wheel 14ag.

The sensor 22ag has an encoding disk 30 formed by a succession of alternating north 32 and south 24 magnetic poles. This disk 30 is mounted on the axle 16.

The sensor 22ag also comprises a sensor housing 36 fixed on a spindle 37 of the wheel 14ag facing the encoding disk 30 and separated therefrom by a gap distance g.

The housing 36 is electrically connected to the data processing unit 24 and to the electric supply system of the vehicle (not shown) by an electric wiring 38 for supplying it with electric energy and for communicating data.

Housing 36 has a parallelepiped shape and houses a printed circuit board on a longitudinal plane CI, as will be explained in more details below. Active elements are mounted on the printed circuit board and are adapted to measure electromagnetic field variations triggered by the successive passages of north and south poles 32, 34 as well as an acceleration of the wheel 14a along a predetermined axis.

Because of the arrangement of the various organs for driving, braking, and turning the wheel, and for reasons of ease of assembly and electrical connections well known in the state of the art, the housing 30 is mounted inclined. The longitudinal plane CI of the housing 36 on which the printed circuit board is arranged thus forms a predetermined and known angle A with respect to the horizontal OXY plane of the wheel 14ag, as is visible on FIG. 3 which is a side view of the housing in the referential OXY.

FIG. 4 is a schematic exploded perspective view of a first embodiment of the sensor housing 36.

The housing 36 is, for example, a rectangular parallelepiped formed by an upper half-shell 40 and a lower half-shell 42 and houses in its central longitudinal plane a plane printed circuit board 44. This board 44 is connected to a block 46 of electrical connections for its electrical supply and the transmission of signals via the electrical cabling 38.

In the area of the front face 48 of the housing 36, which faces the encoding disk 30, a Hall effect encoding cell 50 is mounted on the printed circuit board 44. As is known in itself, this cell 50 is sensitive to magnetic field variations generated by the successive passage of the magnetic poles 32, 34 of the disk 30 in front of the front face 48. The cell 50 thus produces an electric current in the form of substantially crenelated pulses whose frequency depends on the spatial period of poles on the disk 30 and the rotation speed of the wheel 14ag. The disk 30 and the cell 50 constitute a magnetic encoder of the rotation speed of the wheel 14ag.

The cell 50 is supplied with electrical energy by a supply line 52 connected to the connection block 46 and the electrical current that it generates is transmitted to the block 46 by a first data line 54.

A mono-axis accelerometer 56, constituted by a microelectromechanical system in the form of a chip, is also mounted on the board 44 and is adapted to measure the acceleration to which the housing 36 is subjected along a predetermined axis M, here, perpendicular to the plane of the board 44. This accelerometer 44 is provided to measure the acceleration of the center of the wheel 14ag along the OZ axis (FIG. 2), hereinafter called vertical acceleration.

The accelerometer 56 is connected to the line 52 to supply them with electrical energy as well as a ground line 58 connected to the block 46. The accelerometer 56 is further connected to a second data line 60 for transmitting the acceleration measurement to the block 46.

Thus, it will be observed that only five electrical connections are required for the electrical supply and data communication needs of the board 44.

As has been mentioned above, because of the assembly of the housing 36 on the wheel 14ag, the plane of the printed circuit board 44 is inclined by the known angle A with respect to the horizontal plane OXY of the wheel 14ag. In order to extract from the measurement of the accelerometer 56 the component along the vertical axis OZ of the wheel 14ag, filtering means adapted to extract this component are provided.

These filtering means are, for example, provided in the data processing unit 24 and multiply the measurement received from the accelerometer 56 by the cosinus of the angle A to extract the vertical acceleration of the wheel 14ag.

As a variant, the filtering means are mounted on the board 44 in the form of a microcontroller chip.

FIG. 5 is a schematic view of a second embodiment of the housing 36.

Here, the chip of the accelerometer 56 is mounted inclined by an angle B, substantially equal to the angle 180°—A (in degrees), with respect to the plane of the board 44, while being supported on appropriate support means 70. Thus, the measurement axis M of the accelerometer 56 is substantially in a vertical plane of the wheel 14ag.

Thus, the accelerometer 56 directly measures the vertical acceleration of the wheel 14ag and it is not necessary to implement a filtering of the measurement.

As a variant, the chip of the accelerometer 56 is not mounted inclined on the board 44 but the accelerometer 56 measures the acceleration to which the board 44 is subjected along an axis forming the angle B with the plane of the connection pins of the chip of the accelerometer 56. This type of accelerometers is generally called “inclined axis accelerometer.”

FIG. 6 is a schematic exploded perspective view of a third embodiment of the housing 36.

In this embodiment, the housing 36 is formed by an upper half-shell 80 and a lower half-shell 82 angled by an angle B. The housing 36 houses a printed circuit board 84, also angled by an angle B. The board 84 has a first portion P1 on which the encoding cell 50 is mounted and a second portion P2 on which the accelerometer 56 is mounted.

The board 84 is, for example, rigid, or is formed by a flexible film formed so as to be angled by the angle B.

The plane of the portion P1 of the board 84 forms the angle A with the horizontal plane OXY of the wheel 14ag. Thus, the portions P1 and P2 being inclined with respect to one another by the angle B, the portion P2 on which the accelerometer 56 is mounted is substantially in a horizontal plane of the wheel 14ag.

Thus, the accelerometer 56 directly measures the vertical acceleration of the wheel 14ag and consequently, it is not necessary to implement a filtering of the measurement.

As a variant, in the third embodiment, the housing 36 is a rectangular parallelpiped comprising appropriate support and/or fixing means for the angled printed circuit board 84.

Thus, a compact sensor 22ag is obtained, which comprises a single housing and a limited number of electrical connections.

Although a connection block 46 integrated to the sensor housing has been described, as a variant, the connection block is deported in the area of the data processing unit 24.

FIG. 7 is a schematic view of the data processing unit 24.

The unit 24 includes, for each of the pairs of wheels 14ag, 14rg, 14ad, 14rd arranged on a same side of the vehicle 10, a module 90, 92 for the determination of coefficients of stiffness of tires and of magnitudes representative of the radius of wheels. The module 90, 92 receives the measured vertical accelerations Avrg, Avag, Avrd, Avad of the pair of wheels from the corresponding sensors 22rg, 22ag, 22rd, 22ad and determines coefficients of stiffness Kprg, Kpag, Kprd, Kpad of the tires 20rg, 20ag, 20rd, 20ad of the pair of wheels as a function of these measurements.

The module 90, 92 also determines, as a function of the received accelerations, operating points Pfrg, Pfag, Pfrd, Pfad of the wheels of the pair of wheels, i.e., magnitudes representative of their radii, as will be explained in more details below.

The unit 24 also comprises, for each of said pairs of wheels, a module 94, 96 for the frequency determination receiving the measured electromagnetic pulses lcrg, lcag, lcrd, lcad from the corresponding sensors. This module 94, 96 is further connected to the modules 90, 92 for the determination of the coefficients of stiffness and of the magnitudes representative of the radius of the wheels and determines, as a function of the input that it receives, the frequencies fcrg, fcag, fcrd, fcad of the measured electromagnetic pulses, as will be explained in more details below.

Finally, the unit 24 includes a diagnostic module 98 connected to the sensors 22rg, 22ag, 22rd, 22ad and to the various above-mentioned modules 90, 92, 94, 96. The module 98 diagnoses, as a function of the input that it receives, the inflated state of each of the tires 20rg, 20ag, 20rd, 20ad and the operating state of each of the sensors 22rg, 22ag, 22rd, 22ad, as will be described in more details below.

FIG. 8 illustrates a calculation hypothesis used by the modules 90, 92 to determine the coefficients of stiffness of the tires. This figure shows the progress of a motor vehicle on a roadway between two instants t and t+Δt.

As illustrated on this Figure, the front and rear wheels arranged on a same side of the vehicle are subjected to the same profile of the roadway with a temporal delay Δt dependent on the speed V and on the wheel base d of the vehicle. This phenomenon can be modelized according to the equation:

Zsa(t)=Zsr(t+Δt) (1)

where t is time, Δt is the time period separating the passage of the rear wheel on a point of the roadway from the passage of the front wheel on this same point, Zsa is the altitude of the ground in the area of the front wheel and Zsr is the altitude of the ground in the area of the rear wheel.

FIG. 9 is a schematic view of a module 90, 92 for the determination of the coefficients of stiffness and of magnitudes representative of the radius of the wheels, for example, the module 90 associated with the pair of wheels arranged on the left side of the vehicle. The module 90 described in relation to FIG. 9 corresponds to an embodiment associated with sensors 22ag, 22rg of the type described in relation with one of FIGS. 5 and 6.

The module 92 associated with the pair of wheels arranged on the right side is identical to the module 90.

Among the pair of left wheels, the front wheel will be distinguished from the right wheel below.

The module 90 comprises an analog/digital converter 100, for example, a zero order blocker sampler, adapted to digitalize the vertical accelerations Avrg, Avag according to a predetermined sampling period Te, for example, comprised between about 0.001 seconds and 0.02 seconds, and thus to supply as output digital vertical accelerations of the front and rear wheels, where k represents the k^{th} sampling instant.

The sampler 100 is connected to a band-pass filter 102 adapted to process the digital accelerations supplied by the sampler 100 by performing on them a band-pass filtering. This filtering is implemented in a range of frequencies in which the power of the modes of the front and rear wheels is essentially concentrated. This frequency range corresponds to the range of rolling resistance and is, for example, substantially equal to the range [8; 20] Hz.

The module 90 also includes temporally resetting mean 104 connected to the filter 102. These means 104 temporally reset the filtered digital acceleration Avag(k) of the front wheel on the filtered digital acceleration Avrg(k) of the rear wheel to supply as output reset accelerations Avrg(k), Avag(k-n) of the front and rear wheels, corresponding to the same altitude of the ground, in order to apply the hypothesis according to the above-described equation (1).

To this effect, these resetting means 104 comprise computing means 106 that estimate the digital inter-correlation IC(N) of the accelerations Avrg(k), Avag(k) supplied by the filter 102 according to the equation:

$$IC ( N ) = {\sum }_{k = - ∞}^{+ ∞} Avrg ( k ) \times Avag ( N - k ) \qquad ( 2 )$$

The computing means 104 implement an estimator of this inter-correlation, as is known in itself in the field of signal processing.

The resetting means 104 also comprise, connected to the computing means 106, means 108 for determining the maximum of the inter-correlation IC(N) and the sampling instant n corresponding to this maximum. This instant n thus corresponds to the temporal delay n×Te between the front and rear wheels subjected to the same portion of roadway.

Temporal resetting means 110 are connected to the means 108 and to the filter 102, and they apply a delay of n samples to the acceleration Avag(k) of the front wheel and supply an acceleration Avag(k-n) of the front wheel temporally reset on the acceleration Avrg(k) of the rear wheel.

The module 90 further comprises means 112 for estimating the coefficients of pneumatic stiffness Kprg, Kpag of the front and rear wheels. These means 112 are connected to the filter 102 to receive the filtered digital accelerations Avrg(k), Avag(k) of the rear and front wheels and to the resetting means 110 to receive the reset acceleration Avag(k-n) of the front wheel.

The means 112 are based on the mechanical model of FIG. 10 to modelize the dynamic behavior of each of the front and rear wheels.

This Figure illustrates a mono-wheel mechanical model of a wheel R of a four-wheel motor vehicle, connected to the body C thereof by means of a suspension Su, the wheel R being in contact with the ground So.

The body C is modelized by a mass mc reported to the wheel that occupies, on a vertical axis OZ of the vehicle in a referential thereof, an altitude Z_{c} with respect to a reference level NRef, for example, the altitude of the ground So in the area of the front wheel when the vehicle is starting off.

The suspension Su is modelized by a spring having a coefficient of stiffness Kc in parallel with a damper having a damping coefficient Rc. The wheel R is modelized by a mass Mr that occupies, on the OZ axis, an altitude Zr with respect to the reference level Nref. The tire thereof is modelized by a spring having a coefficient of stiffness Kp in contact with the ground So, which occupies, on the OZ axis, an altitude Zs with respect to the reference level Nref.

When the vehicle is moving, the behavior of this mechanical system is controlled by the evolution with time of the altitude Zs of the ground.

In the following, the letter “a” is added to designations of the above magnitudes for magnitudes associated with a front wheel, the letter “r” is added to the above designations for the magnitudes associated with a rear wheel, the letter “g” is added to designations of the above magnitudes for the magnitudes associated with the left side of the vehicle, and the letter “d” is added to the designations of the above magnitudes for the magnitudes associated with the right side of the vehicle.

Using the fundamental principle of dynamics applied to this model in relation with the hypothesis according to the equation (1), the vertical accelerations Avrg(k), Avag(k) of the centers of the wheels are modelized in discrete time according to the equations:

$$\begin{matrix}Avrg ( k ) = \frac{1}{mrrg} ( \begin{matrix}mrag \times Avag ( k - n ) & Zvag ( k - n ) - Zvrg ( k )\end{matrix} ) & ( 3 ) \\ Avag ( k ) = \frac{1}{mrag} ( \begin{matrix}mrrg \times Avrg ( k + n ) & Zvrg ( k + n ) - Zvag ( k )\end{matrix} ) & ( 4 )\end{matrix}$$

where mrrg and mrag are the masses of the rear and front wheels, respectively, and Zvrg and Zvag are the altitudes of the centers of the rear and front wheels, respectively, with respect to the reference level.

Referring again to FIG. 9, the estimation means 112 are adapted to implement a recursive least square algorithm in real time based on the equation (3), according to the equations:

\hat{θ}(k+1)=\hat{θ}(k)+K(k+1)(Avrg(k+1)−A(k+1)\hat{θ}(k)) (5)

K(k+1)= ω̅⁻¹S(k)X^{T}(k+1)(σ²(k)+ ω̅⁻¹A(k+1)S(k)A^{T}(k+1))⁻¹ (6)

S(k+1)= ω̅⁻¹(S(k)−K(k+1)A(k+1)S(k)) (7)

X(k+1)=E(A^{T}(k+1)A(k+1))⁻¹ (8)

σ(k)=Var(e(k)) (9)

where (•)^{T} is the symbol of the transpose, \hat{θ}(k) is the estimate of the vector of the parameters

$$θ = ( \begin{matrix}Kprg / Kpag \\ Kprg\end{matrix} ) at instant k ,$$

A(k) is the regression vector

$$( \begin{matrix}\frac{mrag}{mrrg} \times Avag ( k - n ) & \frac{1}{mrrg} ( Zva ( k - n ) - Zvr ( k ) )\end{matrix} ) at instant k ,$$

E(A^{T}(k)A(k)) is the variance of the vector A^{T} at instant k, Var(e(k)) is the variance of the estimation error e(k)=Avrg(k)−A(k)\hat{θ}(k) at instant k, ω̅ is a predetermined forgetting factor and K(k), X(k) et S(k) are intermediate vectors or matrices used during the estimation of the vector θ.

Preferably, the means 112 calculate the altitudes Zvrg(k), Zvag(k-n) of the centers of the rear and front wheels at each sampling instant as a function of the vertical accelerations Avrg(k) and Avag(k-n), for example, by performing a double integration thereof after their filtering between 8 Hz and 20 Hz. Another example of a calculation of the altitude of a wheel as a function of its vertical acceleration is described in the French patent application FR 2 858 267 in the name of the applicant.

As a variant, the estimating means 112 are adapted to implement a recursive least square algorithm in real time based on the equation (4) in a manner analogous to that described above.

As a variant, the means 112 are adapted to implement an inversion or deconvolution algorithm based on the equation (3) or (4) to estimate the coefficients of stiffness.

The estimating means 112 are thus adapted to supply, at each sampling instant, estimated values Kpag(k) and Kprg(k) of the coefficients of pneumatic stiffness of the front and rear wheels.

As a variant, the means 112 are based on another type of mechanical model to estimate the coefficients of stiffness.

For example, as a variant, the system is based on the mechanical model illustrated on FIG. 11. FIG. 11 is a schematic view of a mechanical model generally designated by the expression “bicycle model.” This type of model makes it possible in particular to take into account the case of active suspensions with which the vehicle is equipped and applies to front and rear wheels arranged on a same side of the vehicle.

The difference with the model of FIG. 10 consists in the fact that the body C of the vehicle is assimilated to a mass mc suspended both on the front wheel Ra and on the rear wheel Rr.

Based on the fundamental principle of dynamics applied to this bicycle model as well as the hypothesis according to the equation (1), the vertical accelerations Avag(k), Avrg(k) of the front and rear wheels are modeled in discrete time according to the equation:

$$Avrg ( k ) = {( \begin{matrix}\frac{mrag}{mrrg} Avag ( k - n ) \\ \frac{1}{mrrg} ( Zvag ( k - n ) - Zvrg ( k ) ) \\ \frac{1}{mnrg} \dot{Z} vag ( k - n ) \\ - \frac{1}{mrrg} \dot{Z} vrg ( k )\end{matrix} )}^{T} ( \begin{matrix}Kprg ( k ) / Kpag ( k ) \\ Kprg ( k ) \\ ( Kprg ( k ) / Kpag ( k ) ) \times Kcag ( k ) \\ Kcrg ( k )\end{matrix} ) \qquad ( 10 )$$

where Żvag et Żvrg are the first derivatives of the altitudes of the centers of the front and rear wheels, respectively, i.e. the speeds of the vertical movements thereof.

The estimating means 112 are then adapted to implement a recursive least square algorithm in real time based on the equation (10).

This algorithm is analogous to that described above (equations (6) to (10)) with the vector of the parameters being defined by the equation:

$$θ = ( \begin{matrix}Kprg / Kpag \\ Kprg \\ ( Kprg / Kpag ) \times Kcag \\ Kcrg\end{matrix} ) \qquad ( 12 )$$

and the regression vector being defined by the equation:

$$A ( k ) = ( \begin{matrix}\frac{mrag}{mrrg} Avag ( k - n ) & \frac{1}{mrrg} ( Zvag ( k - n ) - Zvrg ( k ) ) & \frac{1}{mrrg} \dot{Z} vag ( k - n ) & - \frac{1}{mrrg} \dot{Z} vrg ( k )\end{matrix} ) \qquad ( 13 )$$

The altitudes Zvrg(k), Zvag(k) of the centers of the wheels with respect to the reference level and their first derivatives Żvrg(k), Żvag(k-n) are calculated at each sampling step in a manner analogous to the first embodiment, for example, by integrating the corresponding vertical accelerations or in a manner described in the French patent application FR 2 858 267.

As can be observed, the application of the recursive least square algorithm in real time based on the bicycle model makes it possible to estimate simultaneously the coefficients of pneumatic stiffness Kpag, Kprg as well as the coefficients of stiffness Kcag and Kvrg of the suspensions.

Referring again to FIG. 9, the module 90 finally comprises means 114 for determining operating points connected to the means 112 for estimating the coefficients of stiffness. The means 114 determine the operating points Pfrg, Pfag of each of the front and rear wheels, and more particularly,

$$the ratio \frac{Vcrg}{fcrg} ( k ) , \frac{Vcag}{fcag} ( k )$$

of the longitudinal speed Vcrg, Vcag of the wheel at the frequency fcrg, fcag of the electromagnetic pulses encoding the rotation speed of the wheel. This ratio is proportional to the radius of the wheel and it is observed that it is bijectively linked to the coefficient of stiffness Kprg, Kpag of the tire of the wheel, as illustrated on FIG. 12. This FIG. 12 is a graph of a curve of the evolution, over a range P1, of the coefficient of stiffness of a tire of a wheel as a function of the evolution, over a range P2, of the ratio between the longitudinal speed thereof and the frequency of the pulses encoding the rotation speed of the wheel. The ranges P1 and P2 correspond to values that these two magnitudes can physically take.

The determination means 114 comprise a predetermined mapping of ratio values as a function of coefficient of stiffness values. The means 114 evaluate, at each sampling instant, this mapping for each of the coefficients of stiffness estimated by the means 112 to determine the corresponding ratio

$$\frac{Vcrg}{fcrg} ( k ) , \frac{Vcag}{fcag} ( k ) .$$

FIG. 13 is a schematic view of a module 94, 96 for the determination of the frequencies of the electromagnetic pulses, for example, the module 94 associated with the pair of wheels arranged on the left side of the vehicle.

The module 96 associated with the pair of wheels arranged on the right side is identical to the module 94.

The module 94 comprises a clock 120 supplying a clock signal Clk having a predetermined period T0, for example, equal to 7 milliseconds, and means 122, 124 for determining the frequency fcrg, fcag of the measured pulses associated with each of the rear and front wheels 14rg, 14ag. The means 122 and 124 are identical.

By considering, for example, the means 122 associated with the left rear wheel 14rg, the latter comprise means 126 for determining a time period connected to the clock 120 and receiving the measured electromagnetic pulses lrg of the sensor 22rg associated with the rear wheel 14rg.

The means 126 determine, for each time period T0 defined by two successive rising edges of the clock signal Clk, a time period comprising a whole number of electromagnetic pulses.

FIG. 14 is a time diagram of measured electromagnetic pulses lrg and the clock signal Clk. As illustrated on this Figure, the time period T0 does not necessarily comprise a whole number of pulses because of the asynchronism between the measured pulses and the clock signal Clk.

The means 126 take this into account by calculating, for the time period T0, a period T0+Δrg, with Δrg=(T1−T2), where T1 is the period separating the rising edge that begins the period T0 from the edge of the pulse just before this rising edge, and T2 is the time period separating the rising edge terminating the period T0 from the pulse edge just before this rising edge. The time period T0+Δrg thus comprises a whole number of pulses. The time period Δrg will be called “address” below.

The counting means 122 also comprise means 128 connected to the means 126 for determining the period T0+Δrg, receiving the measured pulses lrg and counting the number of pulses present in the period T0+Δrg.

The counting means 122 are connected to selection means 130. The selection means 130 are also connected to the modules 90, 92 for the determination of the coefficients of stiffness and of the operating points of the wheels and to the diagnostic module 98. The means 130 receive therefrom the operating point Pfrg of the left rear wheel 14rg, the operating point of the wheel mounted on the same axle as the left rear wheel, i.e., here, the operating point Pfrd of the right rear wheel 14rd, the operating point of the wheel located in a diagonal with the left rear wheel 14rg, i.e., here, the operating point Prad of the right front wheel 14ad, and a detection signal DC of an operating point among the operating points received by the means 130.

The DC signal is supplied by the diagnostic module 98 and lists the sensors whose accelerometer part is defective. By default, the means 130 select the operating point Pfrg of the left rear wheel. If the accelerometer part of the sensor associated with the left rear wheel is defective, the means 130 select one or the other of the other operating points.

The means 130 also select, as a function of the selected operating point and of the number of pulses lrg counted during the time period T0+Δrg, an abacus among a predetermined group of abacuses. As is visible on FIG. 15 which illustrates a group of abacuses having pulse frequencies fc as a function of address values Δ, or in an equivalent manner, as a function of the value of the period T0+Δ, it is observed that the frequency fc of the electromagnetic pulses supplied by a sensor is an affine function of the address Δ associated therewith for a given operating point and number of counted pulses.

The selecting means 130 comprise, for each value of one or the other of the other operating points of a predetermined group of operating points, a predetermined group of straight lines. Each of these straight lines is associated with a predetermined value of the pulse number. The means 130 select the group of straight lines associated with the selected operating point, then the straight line of this group associated with counted pulse number. The abacuses of the means 130 are, for example, stored therein in the form of maps.

Referring again to FIG. 13, the means 122 for determining the frequency fcrg comprise means 132 for computing the frequency connected with the selecting means 130 to receive the selected abacus and with the means 126 for determining the period T0+Δrg to receive the address Δrg. The means 132 calculate the frequency fcrg of the pulses supplied by the sensor 22rg associated with the left rear wheel 14rg by evaluating the selected abacus for the address Δrg received.

FIG. 16 is a schematic view of the diagnostic module 98 of the unit 24 of FIG. 7.

The module 98 comprises first comparing means 150 connected to the modules 94, 96 for determining the frequencies frcag, fcad, fcrg, fcrd and comparing these frequencies with one another. If the means 150 determine that these frequencies differ in absolute value by more than a first predetermined threshold value, the means 150 emit a first diagnostic that the tire or tires associated to the lowest frequencies is under-inflated. For example, if the three frequencies are substantially equal and the fourth frequency is lower than them in absolute value by more than the first threshold value, the means 150 emit that the tire associated to this frequency is under-inflated.

The comparison means 150 also compare each of the frequencies to a predetermined second threshold value. The means 150 emit, as first diagnostic, that the tires are all under-inflated if all the frequencies frcag, fcad, fcrg, fcrd are lower than a second threshold value.

The diagnostic module 98 also comprises second comparison means 152 connected to the modules 90, 92 for determining the coefficients of stiffness and magnitudes representative of the radius of the wheels to receive the coefficients of stiffness Kprg, Kpag, Kprd, Kpad and to compare them with one another. If the means 152 determine that these coefficients are different in absolute value by more than a third threshold value, they emit a second under-inflated state diagnostic for the tire or tires associated with the lowest coefficient.

The means 152 also compare each of the coefficients Kprg, Kpag, Kprd, Kpad to a predetermined fourth threshold value. The means 152 emit as second diagnostic that the tires are all under-inflated if all the coefficients Kprg, Kpag, Kprd, Kpad are lower than the fourth threshold value.

The first means 150 and the second means 152 are connected to means 154 for diagnosing the inflated state of the tires. These means 154 diagnose that a tire is under-inflated if the first and the second diagnostic performed by the first and second comparison means 150, 152 coincide.

The module 98 also comprises, for each pair of wheels arranged on a same side of the vehicle, means 156, 158 for diagnosing the accelerometer part of the sensors 22ag, 22ad, 22rg, 22rd associated with the pair of wheels.

Considering, for example, the means 156 associated with the pair of left wheels of the vehicle, these means test the coherence of the accelerations Avrg(k) and Avag(k) with one another over a predetermined time period, comprised, for example, between 5 minutes and 10 minutes. As described above, it is known that the vertical accelerations of the front and rear wheels are coherent since the wheels are subjected to the same portion of the roadway with a temporal delay.

For example, the means 156 calculate the frequency specters of these accelerations by means of a fast Fourier transform of the accelerations comprised in the predetermined time period and compare the calculated specters. If the latter differ by more than a predetermined value, for example, in quadratic error, then the accelerometers of the sensors 22ag, 22rg are diagnosed as defective by the means 156.

The diagnostic module 98 also includes, for each pair of wheels arranged on a same side of the vehicle, means 160, 162 for diagnosing the speed encoding part of the sensors 22ag, 22ad, 22rg, 22rd associated with the pair of wheels.

These means 160, 162 are analogous to the means 156, 158 for diagnosing the accelerometer part of the sensors and test the frequency coherence of the frequencies frcag, fcad, fcrg, fcrd of the pulses measured by the sensors associated with the pair of wheels. The means 156, 160 diagnose a failure of the speed encoding part of these sensors if these frequencies are not coherent.

To increase the robustness in the diagnostic of the operating state of the accelerometers of the sensors 22ag, 22rg, in a variant, the means 156 for diagnosing the accelerometer part of the sensors associated with the pair of left wheels, and in a corresponding manner, the means 158 associated with the pair of right wheels, are further adapted to predict the vertical acceleration of the left rear wheel as a function of the measured vertical acceleration of the left front wheel from the equation (4) by varying the sampling instant n. The means 156 test the coherence between this predicted acceleration of the rear wheel and the acceleration of the front wheel measured, for example, in the above-described manner.

If, in addition, the coherence between these accelerations is not established, then the means 156, 158 diagnose a malfunction of the accelerometers of the sensors 22ag, 22rg.

The diagnostic module 98 also comprises, for each pair of wheels arranged on a same side of the vehicle, means 160, 162 for diagnosing the part encoding the rotation speed of the sensors 22ag, 22ad, 22rg, 22rd associated with the pair of wheels.

Finally, the diagnostic module 98 comprises, connected to the means 156, 158 for diagnosing the accelerometer part of the sensors, means 164 for forming the DC signal listing the sensors whose accelerometer part is diagnosed as defective.

Even though a motor vehicle wheel has been described, it is understood that the invention applies to any type of vehicle wheel, for example, a motorcycle, a multi-axle vehicle (truck), or others.

Similarly, even though a sensor encoding a rotation speed in the form of magnetic pulses has been described, as a variant, the sensor comprises an optical encoder including a toothed disk associated with means for emitting a light beam disposed facing the sensor housing on the other side of the disk and the encoding cell is adapted to measure light variations triggered by the successive passage of the teeth of the disk.

1. Device for measuring a quantity representative of the rotation speed of a vehicle wheel, comprising:
means for encoding the rotation speed of the wheel in the form of electromagnetic pulses;
means for measuring said pulses;
means for determining a time period comprising a whole number of said pulses; and
means for counting the whole number of pulses during this time period,
means for determining a magnitude representative of the radius of the wheel; and
means for determining said quantity as a function of the whole number of pulses, of the time period, and of the magnitude representative of the radius of the wheel.

2. Device according to claim 1, wherein the quantity representative of the rotation speed of the wheel is the frequency of the electromagnetic pulses encoding said speed.

3. Device according to claim 1, wherein the means for determining the magnitude representative of the radius of the wheel comprise means for acquiring vertical accelerations in a referential of the vehicle of the wheel and of another wheel arranged on a same side of the vehicle as the former, and means for estimating a coefficient of stiffness of a tire mounted on the wheel.

4. Device according to claim 3, wherein the estimation means comprise means for temporally resetting one of the acquired accelerations on the other of the acquired accelerations.

5. Device according to claim 3, wherein the means for estimating the coefficient of stiffness are adapted to estimate the latter from a mono-wheel mechanical model of said wheels connected to a body of the vehicle by means of suspensions and having tires assimilated to springs characterized by coefficients of stiffness.

6. Device according to claim 5, wherein the means for estimating the coefficient of stiffness are adapted to estimate the latter based on a model in discrete time of the reset accelerations of the wheel and of the other wheel according to the equation:
$$Avr ( k ) = \frac{1}{mrr} ( \begin{matrix}mra \times Ava ( k - n ) & Zva ( k - n ) - Zvr ( k )\end{matrix} ) ( \begin{matrix}Kpr ( k ) / Kpa ( k ) \\ Kpr ( k )\end{matrix} )$$
where k is the k^{th} sampling instant, mrr is the mass of the rear wheel among the wheel and the other wheel, mra is the mass of the front wheel among the wheel and the other wheel, Avr and Ava are the vertical accelerations of said rear and front wheels, respectively, Zvr and Zva are the altitudes of the centers of said rear and front wheels, respectively, in the referential of the vehicle, Kpr and Kpa are the coefficients of stiffness of the tires of said rear and front wheels, respectively, and n is a resetting instant corresponding to a temporal delay between said rear and front wheels subjected to a same portion of the roadway.

7. Device according to claim 5, wherein the means for estimating the coefficient of stiffness are adapted to estimate the latter based on a model in discrete time of the reset accelerations of the wheel and of the other wheel according to the equation:
$$Ava ( k ) = \frac{1}{mra} ( \begin{matrix}mrr \times Avr ( k + n ) & Zvr ( k + n ) - Zva ( k )\end{matrix} ) ( \begin{matrix}Kpa ( k ) / Kpr ( k ) \\ Kpa ( k )\end{matrix} )$$
where k is the k^{th} sampling instant, mrr is the mass of the rear wheel among the wheel and the other wheel, mra is the mass of the front wheel among the wheel and the other wheel, Avr and Ava are the vertical accelerations of said rear and front wheels, respectively, Zvr and Zva are the altitudes of the centers of said rear and front wheels, respectively, in the referential of the vehicle, Kpr and Kpa are the coefficients of stiffness of the tires of said rear and front wheels, respectively, and n is a resetting instant corresponding to a temporal delay between said rear and front wheels subjected to a same portion of the roadway.

8. Device according to claim 3, wherein the estimating means are adapted to estimate the coefficient of stiffness based on a bicycle mechanical model of a body of the vehicle assimilated to a mass connected to the wheel and to the other wheel by means of suspensions, the wheel and the other wheel having tires assimilated to springs characterized by coefficients of stiffness.

9. Device according to claim 8, wherein the means for estimating the coefficient of stiffness are adapted to estimate the latter based on a model in discrete time of the reset accelerations of the wheel and of the other wheel according to the equation:
$$Avr ( k ) = {( \begin{matrix}\frac{mra}{mrr} Ava ( k - n ) \\ \frac{1}{mrr} ( Zva ( k - n ) - Zvr ( k ) ) \\ \frac{1}{mnr} \dot{Z} va ( k - n ) \\ - \frac{1}{mrr} \dot{Z} vr ( k )\end{matrix} )}^{T} ( \begin{matrix}Kpr ( k ) / Kpa ( k ) \\ Kpr ( k ) \\ ( Kpr ( k ) / Kpa ( k ) ) \times Kca ( k ) \\ Kcr ( k )\end{matrix} )$$
where k is the k^{th} sampling instant, mrr is the mass of the rear wheel among the wheel and the other wheel, mra is the mass of the front wheel among the wheel and the other wheel, Avr and Ava are the vertical accelerations of said rear and front wheels, respectively, Zvr and Zva are the altitudes of the centers of said rear and front wheels, respectively, in the referential of the vehicle, Kpr and Kpa are the coefficients of stiffness of the tires of said rear and front wheels, respectively, n is a resetting instant corresponding to a temporal delay between said rear and front wheels subjected to a same portion of the roadway, Kca and Kcr are coefficients of stiffness of the suspensions of said front and rear wheels, respectively, and Żva and Żvr are the speeds of the vertical movements of the centers of said front and rear wheels, respectively.

10. Device according to claim 3, wherein the means for estimating the coefficient of stiffness are adapted to implement a recursive least square algorithm in real time.

11. Device according to claim 3, wherein the magnitude representative of the radius of the wheel is a number which is a function of the ratio between the longitudinal speed of the wheel and the frequency of said pulses, and the means for determining this magnitude comprise means for estimating said number as a function of the estimated coefficient of stiffness of the tire of the wheel.

12. Device according to claim 1, wherein the means for determining the quantity representative of the rotation speed of the wheel comprise means for selecting an abacus of a predetermined group of abacuses as a function of the determined magnitude representative of the radius of the wheel and of the number of pulses counted and means for estimating said quantity by evaluating the selected abacus for the determined time period.

13. System for determining the state of tires of the wheels of a vehicle, which comprises:
a device according to claim 1 associated to each wheel of the vehicle and supplying a quantity representative of the rotation speed of the wheel; and
means for diagnosing the state of the tires of the vehicle wheels as a function of said supplied quantities.

14. System according to claim 13, wherein the diagnostic means are adapted to diagnose a tire as being under-inflated when the quantity associated with the latter is lower than a quantity associated with the other tires by more than a first predetermined value.

15. System according to claim 14 and comprising a device according to claim 3 associated with each wheel of the vehicle, wherein the devices are adapted to further supply the estimated coefficients of stiffness of the wheels, and the diagnostic means are adapted to diagnose the tire as being under-inflated if, in addition, its estimated coefficient of stiffness is lower than at least one estimated coefficient of stiffness of the other tires by more than a second predetermined value.

16. System according to claim 13, wherein the diagnostic means are adapted to diagnose the tires of the vehicle as being under-inflated if said supplied quantities are lower than a predetermined first threshold value.

17. System according to claim 15, wherein the diagnostic means are adapted to diagnose the tires of the vehicle as being under-inflated if, in addition, said supplied coefficients are lower than a predetermined second threshold value.

18. Method of measuring a quantity representative of the rotation speed of a vehicle wheel, comprising:
a step of encoding the rotation speed of the wheel in the form of electromagnetic pulses;
a step of measuring said pulses;
a step of determining a time period comprising a whole number of said pulses; and
a step of counting the whole number of pulses during this time period,
a step of determining a magnitude representative of the radius of the wheel; and
a step of determining said quantity as a function of the whole number of pulses, of the time period and of the magnitude representative of the radius of the wheel.

19. Method of determining the state of tires of the wheels of a vehicle, comprising:
a method according to claim 18 for each wheel of the vehicle and supplying a quantity representative of the rotation speed of the wheel; and
a step of diagnosing the state of the tires of the vehicle wheels as a function of said supplied quantities.
